(19) United States
(12) Patent Application Publication
(10) Pub. No.: US 2022/0304221 A1
(43) Pub. Date: Sep. 29, 2022

(54) Method for determining suitable spreading settings

(71) Applicant: Amazonen-Werke H. Dreyer SE & Co. KG, Hasbergen (DE)

(72) Inventors: Markus STRÖBEL-FRÖSCHLE, Georgsmarlenhütte (DE); Florian RAHE, Lotte (DE)

(21) Appl. No.: 17/619,964

(22) PCT Filed: May 19, 2020
(86) PCT No.: PCT/EP2020/063898

§ 371 Date: Dec. 16, 2021

(30) Foreign Application Priority Data
Jun. 19, 2019 (DE) 10 2019 116 615.2

(51) Int. Cl. A01C 17/00; B05B 12/08

(52) U.S. Cl. CPC A01C 17/008; B05B 12/082; A01C 17/001

(57) ABSTRACT

The invention relates to a method for determining suitable spreading settings for an agricultural spreading machine (10) for achieving an intended spreading material distribution of a spreading material (30) across an agricultural area (12), comprising the steps of: determining the current ejection direction of the ejected spreading material (30) during a spreading operation and determining a suitable application point setting for the agricultural spreading machine (10) taking into account the determined current ejection direction of the ejected spreading material (30) and an ejection direction for the ejected spreading material (30) which is suitable for achieving the intended spreading material distribution during the spreading operation.

The invention relates to a method for determining suitable spreading settings according to the preamble of claim 1, to a method for controlling and/or regulating spreading settings according to the preamble of claim 11, and to an agricultural spreading machine according to the preamble of claim 13.

When spreading material is spread across an agricultural area, suitable spreading settings must be made at the agricultural spreading machine in order to be able to implement the intended distribution of spreading material across the agricultural area. Modern agricultural spreading machines already have control and/or regulating devices by way of which spreading settings are adjusted in an automated manner by the spreading machine during the spreading operation.

For determining the suitable spreading settings for the agricultural spreading machine to achieve an intended spreading material distribution across an agricultural area, it is known, for example, to measure by sensor the current ejection direction of the ejected spreading material during the spreading operation by way of an ejection direction detection device. For detecting by sensor the ejection direction, several sensors have hitherto been required which are to be positioned in the vicinity of the spreading disk and which detect by sensor the flight directions of the ejected spreading material.

The direct detection by sensor of the current ejection direction has hitherto been associated with high component and implementation costs, which leads to a considerable increase in the cost of the agricultural spreading machine.

The object underlying the invention is to simplify determining suitable spreading settings for an agricultural spreading machine, taking into account the current ejection direction of the ejected spreading material.

The object is satisfied by a method for determining suitable spreading settings of the type mentioned at the outset, where the current ejection distance of the ejected spreading material is detected by sensor within the scope of the method according to the invention by an ejection distance measuring device of the agricultural spreading machine. The current ejection direction of the ejected spreading material is determined by a data processing device on the basis of spreading material properties of the spreading material that are specific to the spreading material and influence the flight behavior of the spreading material and on the current detected ejection distance of the ejected spreading material.

The invention makes use of the knowledge that the current ejection direction of the ejected spreading material does not necessarily have to be detected directly by sensor, but can also be calculated without a respective ejection direction measuring device. When calculating the current ejection direction, however, spreading material properties that are specific to the spreading material and influence the flight behavior of the spreading material as well as the current ejection distance of the ejected spreading material are to be taken into account in order to be able to carry out a precise calculation of the ejection direction. Detecting by sensor the current ejection distance of the ejected spreading material is technically much simpler and therefore also less expensive to implement than the direct detection by sensor of the current ejection direction of the ejected spreading material. No expensive ejection direction detection device for direct detection by sensor of the current ejection direction of the ejected spreading material is then to be provided at the agricultural spreading machine, whereby the production costs of a respective intelligent agricultural spreading machine are reduced considerably.

A suitable application point setting for the agricultural spreading machine is determined in the context of the method according to the invention. The application position of the spreading material onto at least one spreading disk of the agricultural spreading machine can be set by way of the application point setting. The method preferably also comprises providing the spreading material properties of the spreading material that are specific to the spreading material and influence the flight behavior of the spreading material to the data processing device and/or providing the detected current ejection distance of the ejected spreading material to the data processing device.

The data processing device can be part of the agricultural spreading machine or a remote evaluation computer. If the data processing device is part of the agricultural spreading machine, providing the spreading material properties of the spreading material that are specific to the spreading material and influence the flight behavior of the spreading material to the data processing device and/or providing the detected current ejection distance of the ejected spreading material to the data processing device is preferably in a wired manner. If the data processing device is part of a remote evaluation computer, providing the spreading material properties of the spreading material that are specific to the spreading material and influence the flight behavior of the spreading material to the data processing device and/or providing the detected current ejection distance of the ejected spreading material to the data processing device is preferably wireless, in particular via radio and/or using the internet.

The ejection distance measuring device can comprise only one or, alternatively, several sensors and/or only one or, alternatively, several cameras which monitor a spread pattern created by the ejection of the spreading material. The one or more sensors of the ejection distance measuring device can determine the ejection distance of the ejected spreading material, for example, according to the Doppler principle or by way of time-shifted distance and/or speed measurements. The one or more sensors of the ejection distance measuring device can be in particular radar sensors.

In a preferred embodiment of the method according to the invention, the current application point setting of the agricultural spreading machine is determined during the spreading operation. Determining the current ejection direction of the ejected spreading material by the data processing device is preferably also carried out on the basis of the determined current application point setting of the agricultural spreading machine. The current application point setting of the agricultural spreading machine can be, for example, read out from the control device of the agricultural spreading machine. The method preferably also comprises providing the determined current application point setting of the agricultural spreading machine to the data processing device. If the data processing device is part of the agricultural spreading machine, providing the determined current application point setting is preferably in a wired manner. If the data processing device is part of a remote evaluation computer, providing the current application point setting to the data processing device is preferably wireless, in particular via radio and/or using the internet

In a further preferred embodiment of the method according to the invention, the current rotational disk speed of at least one spreading disk of the agricultural spreading machine is determined during the spreading operation. Determining the current ejection direction of the ejected spreading material by the data processing device is preferably also carried out on the basis of the determined current rotational disk speed of the at least one spreading disk of the agricultural spreading machine. The current rotational disk speed of the at least one spreading disk of the agricultural spreading machine can be, for example, read out from the control device of the agricultural spreading machine. In the alternative or in addition, a rotational speed sensor can also be used to detect the rotational speed. The method preferably also comprises providing the detected current rotational disk speed to the data processing device. If the data processing device is part of the agricultural spreading machine, providing the detected current rotational disk speed to the data processing device is preferably in a wired manner. If the data processing device is part of a remote evaluation computer, providing the detected current rotational disk speed to the data processing device is preferably wireless, in particular via radio and/or using the internet

In another preferred embodiment of the method according to the invention, spreading material properties that are specific to the spreading material and influence the flight behavior of the spreading material relate to the bulk density and/or grain size and/or grain shape properties of the spreading material. The grain size properties of the spreading material can relate to the mean grain size and/or the grain size spectrum of the spreading material. The data processing device can determine, in particular calculate, the dwell time of the spreading material on the spreading disk of the spreading machine on the basis of the spreading material properties that are specific to the spreading material and influence the flight behavior of the spreading material. The data processing device can determine, in particular calculate, the current ejection direction of the ejected spreading material on the basis of the detected current ejection distance of the ejected spreading material and the determined dwell time of the spreading material on the spreading disk.

In a further development of the method according to the invention, spreading material information is detected, by way of which the spreading material can be identified. In the alternative or in addition, the spreading material properties of the spreading material that are specific to the spreading material and influence the flight behavior of the spreading material are retrieved from a spreading database, in particular on the basis of the detected spreading material identification information. Detecting the spreading material identification information and/or retrieving the spreading material properties that of the spreading material are specific to the spreading material and influence the flight behavior of the spreading material from the spreading database can be effected, for example, directly by the spreading machine or a mobile terminal which then transmits the retrieved spreading material properties of the spreading material that are specific to the spreading material and influence the flight behavior of the spreading material to the spreading machine. For detecting the spreading material identification information, for example, input by a user at an input device, in particular at the spreading machine, or a mobile terminal device may be necessary. The mobile terminal can be a portable mobile radio device, in particular a smartphone. The spreading material identification information can comprise a spreading material designation that is specific to the spreading material or a spreading material identifier that is specific to the spreading material. Providing the spreading material properties that are specific to the spreading material and influence the flight behavior of the spreading material to the data processing device can comprise transmitting retrieved spreading material properties that are specific to the spreading material and influence the flight behavior of the spreading material to the data processing device.

The method according to the invention is further developed advantageously in that at least one image recoding of the spreading material is generated and/or the spreading material properties of the spreading material that are specific to the spreading material and influence the flight behavior of the spreading material are determined by evaluating the generated image recording of the spreading material. For example, grain shape properties, the grain size spectrum, the mean grain size, and/or the bulk density of the spreading material can be determined by evaluating the image recording generated. The at least one image recording of the spreading material is preferably generated by way of a mobile terminal. Evaluating the image recording generated for determining the spreading material properties of the spreading material that are specific to the spreading material and influence the flight behavior of the spreading material is preferably carried out via the mobile terminal or a remote evaluation computer to which the mobile terminal transmits the image recording generated. Providing the spreading material properties that are specific to the spreading material and influence the flight behavior of the spreading material to the data processing device can comprise transmitting retrieved spreading material properties that are specific to the spreading material and influence the flight behavior of the spreading material from the mobile terminal or the evaluation computer to the data processing device.

In another preferred embodiment of the method according to the invention, a user is provided with an input option for the spreading material properties of the spreading material that are specific to the spreading material and influence the flight behavior of the spreading material. The input option can be provided, for example, via an input device of the spreading machine or a mobile terminal. Providing the spreading material properties that are specific to the spreading material and influence the flight behavior of the spreading material to the data processing device can comprise transmitting a user input from the input device of the spreading machine or the mobile terminal to the data processing device. The mean grain size and/or the bulk density of the spreading material can be determined, for example, by way of a weight detection device, such as a scale, and a volume detection device, such as a measuring cup, before the corresponding information is entered. In the alternative or in addition, a graphic code is read out which contains the spreading material properties that are specific to the spreading material and influence the flight behavior of the spreading material. The graphic code can be read out using a code scanner of the spreading machine or a mobile terminal. Providing the spreading material properties that are specific to the spreading material and influence the flight behavior of the spreading material to the data processing device can comprise transmitting spreading material information read from a graphic code by the code scanner of the spreading machine or the mobile terminal to the data processing device. As an alternative or in addition, the spreading material properties that are specific to the spreading material and influence the flight behavior of the spreading material are received from a transmission device by a reading device. The transmission unit can be a transponder, in particular an RFID transponder. The transmission unit can also be a Bluetooth low energy signal transmitter, i.e. a so-called Bluetooth LE beacon. Providing the spreading material properties that are specific to the spreading material and influence the flight behavior of the spreading material to the data processing device can comprise transmitting the spreading material properties that are specific to the spreading material and influence the flight behavior of the spreading material to the data processing device from the reading device to the data processing device.

In a further preferred embodiment of the method according to the invention, the current ejection direction of the ejected spreading material is determined without the use of an ejection direction measuring device. In an alternative embodiment, the current ejection direction determined by the data processing device can be used to check the plausibility of the measurement data from an ejection direction measuring device of the spreading machine. As an alternative, the measurement data of an ejection direction measuring device can be used to check the plausibility of the current ejection direction determined by the data processing device.

In addition, a method according to the invention is advantageous in which the type of spreading disk mounted on the agricultural spreading machine is detected. Determining the current ejection distance of the ejected spreading material and/or determining the suitable application point setting for the agricultural spreading machine is preferably also carried out taking into account the type of spreading disk mounted on the agricultural spreading machine. Types of spreading disks can differ from one another, for example, with regard to their geometry and/or features. For example, spreading disks of different types of spreading disks also differ with regard to their diameter and/or the number and/or design of their ejection vanes. The spreading disk used has a significant influence on the flight behavior of the ejected spreading material. The current ejection direction of the ejected spreading material can therefore be calculated particularly precisely when taking into account the type of spreading disk mounted. The method preferably further comprises providing the information about the type of spreading disk mounted on the agricultural spreading machine to the data processing device. The method preferably further comprises providing the information about the type of spreading disk mounted on the agricultural spreading machine to the data processing device. If the data processing device is part of a remote evaluation computer, providing information about the type of spreading disk mounted on the agricultural spreading machine to the data processing device is preferably wireless, in particular via radio and/or using the internet.

In a further preferred embodiment of the method according to the invention, detecting the type of spreading disk mounted on the agricultural spreading machine comprises providing an input option for providing information about the type of spreading disk mounted on the agricultural spreading machine. The input option can be provided, for example, via an input device of the spreading machine or a mobile terminal device. Providing information about the type of spreading disk mounted on the agricultural spreading machine can comprise transmitting user input from the input device of the spreading machine or the mobile terminal to the data processing device. In the alternative or in addition, detecting the type of spreading disk mounted on the agricultural spreading machine comprises reading out a graphic code which contains information about the type of spreading disk mounted on the agricultural spreading machine. The graphic code can be read out using a code scanner of the spreading machine or a mobile terminal. Providing information about the type of spreading disk mounted on the agricultural spreading machine can comprise transmitting information read out from a graphic code on the type of spreading disk mounted on the agricultural spreading machine from the code scanner of the spreading machine or the mobile terminal to the data processing device. In the alternative or in addition, detecting the type of spreading disk mounted on the agricultural spreading machine comprises receiving information about the type of spreading disk mounted on the agricultural spreading machine from a transmission unit by a reading device. The transmission unit can be a transponder, in particular an RFID transponder. The transmission unit can also be a Bluetooth low energy signal transmitter, i.e. a Bluetooth LE beacon. Providing information about the type of spreading disk mounted on the agricultural spreading machine can comprise transmitting information received by the reading device on the type of spreading disk mounted on the agricultural spreading machine from the reading device to the data processing device.

The object underlying the invention is furthermore satisfied by a method for controlling and/or regulating spreading settings of the type mentioned at the outset, where the suitable spreading settings are determined using a method according to one of the embodiments described above. With regard to the advantages and modifications of the method according to the invention for controlling and/or regulating spreading settings, reference is first made to the advantages and modifications of the method according to the invention for determining suitable spreading settings. In a preferred embodiment of the method, setting the determined suitable spreading settings at the agricultural spreading machine in an automated manner comprises setting the point of application of the spreading material on a spreading disk of the agricultural spreading machine in an automated manner to adapt the current ejection direction of the spreading material to an ejection direction of the ejected spreading material that is suitable for achieving the intended spreading material distribution. In the alternative or in addition, setting the determined suitable spreading settings at the agricultural spreading machine in an automated manner comprises setting a rotational disk speed to adapt the current ejection distance of the spreading material to an ejection distance of the ejected spreading material that is suitable for achieving the intended spreading material distribution. Determining suitable spreading settings preferably also comprises determining an ejection distance of the ejected spreading material that is suitable for achieving the intended spreading material distribution.

The object underlying the invention is further satisfied by an agricultural spreading machine of the type mentioned at the outset, where the agricultural spreading machine according to the invention comprises a data processing device which is configured to determine the current ejection direction of the ejected spreading material on the basis of the spreading material properties that are specific to the spreading material and influence the flight behavior of the spreading material and the determined current ejection distance of the ejected spreading material.

The ejection distance measuring device can comprise only one or, alternatively, several sensors and/or only one or, alternatively, several cameras which monitor a spread pattern created by the ejection of the spreading material. The one or more sensors of the ejection distance measuring device can determine the ejection distance of the ejected spreading material according to the Doppler principle or by way of time-shifted distance and/or speed measurements. The one or more sensors of the ejection distance measuring device can be in particular radar sensors.

In addition, an agricultural spreading machine according to the invention is preferred which is configured to carry out the method for determining suitable spreading settings according to one of the embodiments described above or the method for controlling and/or regulating spreading settings according to one of the embodiments described above. With regard to the advantages and modifications of the agricultural spreading machine according to the invention, reference is made to the advantages and modifications of the method according to the invention for determining suitable spreading settings and the method according to the invention for controlling and/or regulating spreading settings.

Preferred embodiments of the invention shall be explained and described in more detail below with reference to the accompanying drawings, where

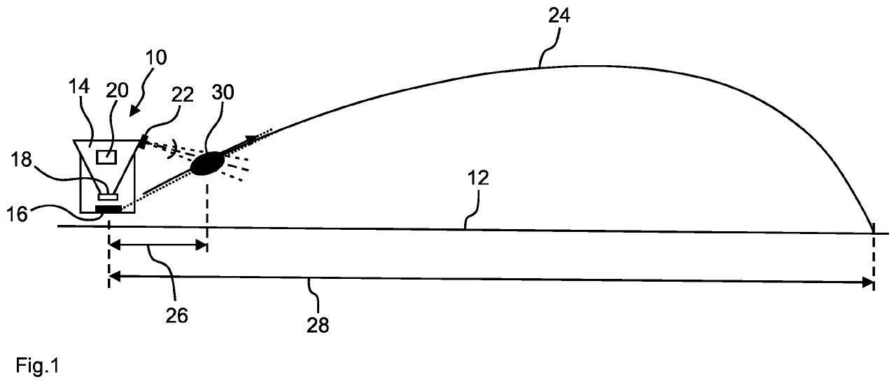

FIG. 1 shows an embodiment of a spreading machine according to the invention while determining suitable spreading settings; and

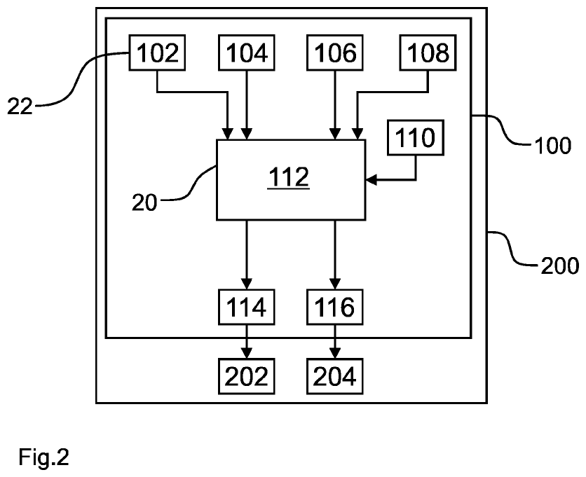

FIG. 2 shows an embodiment of the method according to the invention for controlling and/or regulating spreading settings at an agricultural spreading machine in a schematic block diagram.

FIG. 1 shows an agricultural spreading machine 10 configured as a dual-disk centrifugal fertilizer spreading machine during the distribution of spreading material 30 across an agricultural area 12. Agricultural spreading machine 10 comprises a storage container 14 for storing spreading material 30 to be distributed. Spreading material 30 to be distributed is presently granular fertilizer. During the distribution of the spreading material, spreading material 30 disposed in storage container 14 arrives via spreading material delivery system 18 at two spreading disks 16 arranged next to one another and driven to rotated. Ejection distance 28 of spreading material 30 can be influenced by way of the rotational disk speed. Spreading material introduction systems 18 allow the quantity of the point of application of spreading material 30 onto respective spreading disk 16 to be set. The application position of spreading material 30 onto respective spreading disk 16 of agricultural spreading machine 16 can be set by way of the application point setting. The ejection direction of spreading material 30 can be influenced by way of the application point of spreading material 30. FIG. 1 shows an example of a trajectory 24 of a fertilizer grain 30.

Agricultural spreading machine 10 comprises an ejection distance measuring device 22 which is configured to detect by sensor current ejection distance 28 of ejected spreading material 30. For this purpose, ejection distance measuring device 22 comprises a sensor which monitors the spread pattern created by the ejection of the spreading material. The sensor of ejection distance measuring device 22 uses speed measurements of ejected spreading material 30 for determining ejection distance 28. For this purpose, the speed of ejected spreading material 30 is determined at a measuring distance 26 of approximately 3 m from spreading disks 16.

Agricultural spreading machine 10 further comprises a data processing device 20 which is configured to determine the current ejection direction of ejected spreading material 30 on the basis of detected current ejection distance 28 of ejected spreading material 30. When determining the current ejection direction of ejected spreading material 30, data processing device 20 takes into account not only detected current ejection distance 28 but also the spreading material properties of spreading material 30 that are specific to the spreading material and influence the flight behavior of spreading material 30.

Agricultural spreading machine 10 illustrated performs a calculation for determining the current ejection direction of ejected spreading material 30. Calculated current ejection direction 10 is taken into account by agricultural spreading machine 10 when determining suitable spreading settings for achieving an intended distribution of spreading material 30 across agricultural area 12. The determined suitable spreading settings are set by agricultural spreading machine 10 during the spreading operation by a control and/or regulating device of spreading machine 10 in an automated manner so that the intended spreading material distribution is implemented without control intervention by the machine operator.

In the embodiment shown, data processing device 20, which calculates the current ejection direction of ejected spreading material 30, is part of agricultural spreading machine 10. Alternatively, data processing device 20 can also be part of a remotely positioned evaluation computer. The evaluation computer can be, for example, a server which is operated by the manufacturer of agricultural spreading machine 10. The data transmission between the agricultural spreading machine and data processing device 20 in this case can take place via radio and/or using the Internet.

FIG. 2 shows the sequence of a method 200 for controlling and/or regulating spreading settings at an agricultural spreading machine 10. In the context of this method 200, suitable spreading settings for agricultural spreading machine 10 are first determined for achieving an intended spreading material distribution of spreading material 30 across an agricultural area 12. Determining the suitable spreading settings takes place within the scope of method step 100. For this purpose, current ejection distance 28 of ejected spreading material 30 during the spreading operation is first detected by sensor in method step 102 by an ejection distance measuring device 22 of agricultural spreading machine 10. Current ejection distance 28 of ejected spreading material 30 detected by sensor is then made available to a data processing device 20. Data processing device 20 can be part of agricultural spreading machine 10 or part of a remotely positioned evaluation computer with which agricultural spreading machine 10 can exchange data

The current application point setting of the agricultural spreading machine is determined in step 104 during the spreading operation. The current application point setting of agricultural spreading machine 10 can be, for example, read out from the control device of agricultural spreading machine 10.

The current rotational disk speed of spreading disks 16 of agricultural spreading machine 10 is determined in step 106 during the spreading operation. The current rotational disk speed of spreading disks 16 of agricultural spreading machine 10 can be, for example, read out from the control device of agricultural spreading machine 10 or be detected by way of corresponding rotational speed sensors.

The spreading material properties that are specific to the spreading material and influence the flight behavior of spreading material 30 are determined in step 108. The spreading material properties that are specific to the spreading material and influence the flight behavior of spreading material 30 relate to the bulk density and the grain size spectrum of spreading material 30. The spreading material properties that are specific to the spreading material and influence the flight behavior of spreading material 30 are retrieved from a spreading database. The data is retrieved on the basis of spreading material identification information by way of which spreading material 30 can be identified and which was provided by a user via a mobile terminal. The spreading material identification information provided by the user comprises a spreading material designation that is specific to the spreading material for which spreading material properties are stored in the spreading database. The spreading material properties that are specific to the spreading material and influence the flight behavior of spreading material 30 are also made available to data processing device 20.

The type of spreading disk mounted on agricultural spreading machine 10 is detected in step 110. The type of spreading disk mounted on agricultural spreading machine 10 is detected, for example, by a code scanner of spreading machine 10 reading out a graphic code, where the graphic code contains information about the type of spreading disk mounted on agricultural spreading machine 10. The information about the type of spreading disk mounted on agricultural spreading machine 10 is then made available to data processing device 20. The information about the type of spreading disk mounted on agricultural spreading machine 10 comprises information on the diameter and/or on the ejection vane configuration of the spreading disks.

The current ejection direction of ejected spreading material 30 is determined in step 112 during the spreading operation. The current ejection direction of ejected spreading material 30 is calculated based on the detected current ejection 28 of ejected spreading material 30, the current application point setting of agricultural spreading machine 10, the current rotational disk speed of spreading disks 16 of agricultural spreading machine 10, the spreading material properties that are specific to the spreading material and influence the flight behavior of spreading material 30. The current ejection direction of ejected spreading material 30 is therefore detected without the use of measurement data from an ejection direction measuring device of spreading machine 10.

Once the current ejection direction of ejected spreading material 30 has been determined during a spreading operation, a suitable application point setting for agricultural spreading machine 10 is determined in step 114 taking into account the determined current ejection direction of ejected spreading material 30 and an ejection direction for the ejected spreading material 30 which is suitable for achieving the intended spreading material distribution during the spreading operation. A suitable rotational disk speed for agricultural spreading machine 10 is determined in step 116 taking into account the detected current ejection distance of ejected spreading material 30 and an ejection distance for ejected spreading material 30 suitable for achieving the intended spreading material distribution.

Method 200 for controlling and/or regulating the spreading settings at agricultural spreading machine 10 is concluded by steps 202, 204. Step 202 relates to the automated setting of the application point of spreading material 30 onto spreading disks 16 of agricultural spreading machine 10 to adapt the current ejection direction of spreading material 30 to the ejection direction of the ejected spreading material suitable for achieving the intended spreading material distribution. Step 204 relates to the automated setting of a rotational disk speed for adapting current ejection distance 28 of spreading material 30 to the ejection distance of ejected spreading material 30 that is suitable for achieving the intended spreading material distribution.

### LIST OF REFERENCE NUMERALS

10 spreading machine
12 agricultural land
14 storage container
16 spreading disks
18 spreading material introduction systems
20 data processing device
22 ejection distance measuring device
24 trajectory
26 measuring distance
28 ejection distance
30 spreading material
100-116 method steps
200-204 method steps

1. A method for determining suitable spreading settings for an agricultural spreading machine for achieving an intended spreading material distribution of a spreading material across an agricultural area, comprising the steps of:
determining the current ejection direction of said ejected spreading material during the spreading operation, and
determining a suitable application point setting for said agricultural spreading machine taking into account said determined current ejection direction of said ejected spreading material and an ejection direction for said ejected spreading material which is suitable for achieving the intended spreading material distribution during the spreading operation; characterized by the step of:
detecting by sensor the current ejection distance of said ejected spreading material during the spreading operation by an ejection distance measuring device of said agricultural spreading machine;
where said current ejection direction of said ejected spreading material is determined by a data processing device on the basis of spreading material properties of said spreading material that are specific to said spreading material and influence the flight behavior of said spreading material and on said current detected ejection distance of said ejected spreading material.

2. The method of claim 1, characterized by the step of:
determining the current application point setting of said agricultural spreading machine during the spreading operation;
where determining said current ejection direction of said ejected spreading material by said data processing device is also carried out on the basis of said determined current application point setting of said agricultural spreading machine.

3. The method of claim 1, characterized by the step of:
determining the current rotational disk speed of at least one spreading disk of said agricultural spreading machine during the spreading operation;
where determining said current ejection direction of said ejected spreading material by said data processing device is carried out also on the basis of said determined current rotational disk speed of at least one spreading disk of said agricultural spreading machine.

4. The method of claim 1, characterized in that said spreading material properties that are specific to said spreading material and influence the flight behavior of said spreading material relate to the bulk density and/or grain size and/or grain shape properties of said spreading material.

5. The method according to claim 1, characterized by at least one of the following steps:
detecting spreading material information, by way of which said spreading material can be identified;
retrieving said spreading material properties of said spreading material that are specific to said spreading material and influence the flight behavior of said spreading material from a spreading database, in particular on the basis of the detected spreading material identification information.

6. The method of claim 1, characterized by at least one of the following steps:
generating at least one image recording of said spreading material;
determining said spreading material properties of said spreading material that are specific to said spreading material and influence the flight behavior of said spreading material by evaluating said generated image recording of said spreading material.

7. The method according to one of claim 1, characterized by at least one of the following steps:
providing an input option for said spreading material properties of said spreading material that are specific to said spreading material and influence the flight behavior of said spreading material to a user;
reading out a graphic code which contains said spreading material properties of said spreading material that are specific to said spreading material and influence the flight behavior of said spreading material;
receiving said the spreading material properties of said spreading material that are specific to said spreading material and influence the flight behavior of said spreading material from a transmission device by a reading device.

8. The method according to one claim 1, characterized in that determining said current ejection direction of ejected spreading material is made without the use of measurement data from an ejection direction measuring device of spreading machine.

9. The method according to claim 1, characterized by at least one of the following steps:
detecting the type of spreading disk mounted on said agricultural spreading machine;
where determining said current ejection distance of said ejected spreading material and/or determining said suitable application point setting for said agricultural spreading machine is carried out taking into account the type of spreading disk mounted on said agricultural spreading machine.

10. The method according to claim 9, characterized in that detecting the type of spreading disk mounted on said agricultural spreading machine comprises at least one of the following steps:
providing an input option for providing information on the type of spreading disk mounted on said agricultural spreading machine;
reading out a graphic code which contains information on the type of spreading disk mounted on said agricultural spreading machine; and
receiving information on the type of spreading disk mounted on said agricultural spreading machine from a transmission unit by a reading device.

11. The method for controlling and/or regulating spreading settings at an agricultural spreading machine, comprising the steps of:
determining suitable spreading settings at an agricultural spreading machine for achieving an intended spreading material distribution of a spreading material across an agricultural area; and
automated setting of said determined suitable spreading settings at said agricultural spreading machine during a spreading operation by a control and/or regulating device of said spreading machine; and
characterized in that said suitable spreading settings are determined using a method according to claim 1.

12. The method according to claim 11, characterized in that the automatic setting of said determined suitable spreading settings at said agricultural spreading machine comprises at least one of the following steps:
automated setting of the application point of said spreading material on a spreading disk of said agricultural spreading machine to adapt the current ejection direction of said spreading material to an ejection direction of said ejected spreading material suitable for achieving the intended spreading material distribution;
automated setting of a rotational disk speed for adapting said current ejection distance of said spreading material to an ejection distance of said ejected spreading material that is suitable for achieving the intended spreading material distribution.

13. Agricultural spreading machine with:
an ejection distance measuring device which is configured to detect by sensor said current ejection distance of said ejected spreading material;
characterized by a data processing device which is configured to determine the current ejection direction of said ejected spreading material on the basis of spreading material properties of said spreading material that are specific to said spreading material and influence the flight behavior of said spreading material and on said current detected ejection distance of said ejected spreading material.

14. Agricultural spreading machine according to claim 13, characterized in that said agricultural spreading machine is configured to carry out the method for determining suitable spreading settings according to claim 1 and/or the method for controlling and/or regulating spreading settings according to claim 11.
